(19) United States
(12) Patent Application Publication
(10) Pub. No.: US 2019/0078243 A1
(43) Pub. Date: Mar. 14, 2019

(54) METHOD FOR PRODUCING A FIBER MATRIX SEMI-FINISHED PRODUCT

(71) Applicant: LANXESS DEUTSCHLAND GMBH, KOLN (DE)

(72) Inventors: MATTHIAS BIENMULLER, KREFELD (DE); DETLEV JOACHIMI, KREFELD (DE); WOLFGANG WAMBACH, KOLN (DE); JOCHEN ENDTNER, KOLN (DE)

(73) Assignee: LANXESS DEUTSCHLAND GMBH, KOLN (DE)

(21) Appl. No.: 15/762,842

(22) PCT Filed: Sep. 28, 2016
(86) PCT No.: PCT/EP2016/073091

§ 371 Date: Mar. 23, 2018

(30) Foreign Application Priority Data
Oct. 1, 2015 (EP) 15187840.2

(51) Int. Cl. D04H 1/60; D04H 3/04; D04H 3/12; B29B 15/10; B29C 70/46; B29B 9/10; B29B 9/14; B29B 11/12

(52) U.S. Cl. CPC D04H 1/60; D04H 3/04; D04H 3/12; B29B 15/105; B29K 2101/12; B29B 9/10; B29B 9/14; B29B 11/12; B29C 70/465

(57) ABSTRACT

The present invention relates to a process, especially impregnation process, for producing a semifinished fiber matrix product using micropellets.

The present invention relates to a process, especially impregnation process, for producing a semifinished fiber matrix product using micropelletized materials.

### PRIOR ART

In demanding applications, for example moldings for motor vehicle construction and aviation applications, fiber composite materials are desirable owing to a unique combination of low weight, high strength and thermal stability.

Fiber composite materials are produced using a fiber material-comprising semifinished fiber product. Semifinished fiber products are preferably nonwoven structures, textiles, weaves, unconsolidated fiber webs and combinations thereof. Fiber materials are rovings, i.e. bundles, strands or multifilament yarns composed of parallel filaments/endless fibers or long fibers. For the production of fiber composite structures, also called semifinished fiber matrix products, these semifinished fiber products or the fiber materials present therein are impregnated with a polymer resin composition. The process to be employed here with preference is nowadays powder impregnation.

In powder impregnation, the polymer resin composition to be used for the matrix of the semifinished fiber matrix product is applied in powder form to the fiber materials or to the semifinished fiber product. The powder is preferably applied by scattering, trickling, printing, irrigating, spraying, thermal spraying or flame spraying, or by fluidized bed coating methods. Subsequently, the powder-laden or powder-coated semifinished fiber products are subjected to thermal pressing, wherein the long fibers or continuous fibers in the semifinished fiber product are very substantially impregnated and consolidated.

Composite structures composed of fiber material based on carbon fibers are of particular interest since the carbon fibers in particular lead to very good mechanical properties in semifinished fiber matrix products and the end products that can be produced therefrom.

If even the impregnation of glass fibers is a critical factor in the production of semifinished fiber matrix products, the impregnation of fiber material composed of carbon fibers with thermoplastic polymers can be particularly difficult. This is especially true of fiber material of high basis weight, or in the case of use of polar polymers because of the low polarity of carbon fibers.

Current methods using ground polymer compositions additionally have the drawback of a high dust content. This necessitates energy-intensive suction processes during the production of the semifinished fiber matrix products, which leads to environmental pollution and higher costs. Filtered dust residues have to be disposed of. The dust content also leads to elevated dust nuisance in the air in the factory halls, which can be a matter of concern with regard to occupational hygiene aspects (employee exposure) and the risk of dust gas explosions. Ground polymer compositions are produced by grinding. In general, this is done at low temperatures by a cryogenic grinding method, for example by cooling with liquid nitrogen followed by mechanical grinding. This grinding operation too is very energy-intensive and costly. Moreover, there is a high risk that, in the course of grinding (condensation of air humidity as a result of low temperatures) or thereafter, the ground polymer composition will absorb moisture because of the considerably increased surface area of the ground material. In the case of use of polymers, moisture leads to inferior quality (low surface quality, poorer mechanical properties) of the semifinished fiber matrix product owing to polymer degradation and outgassing of the moisture.

The grinding of polymer compositions, moreover, is an additional process step in which there is a risk that there will be unwanted contamination with correspondingly adverse effects on the semifinished fiber matrix product or the properties thereof. Contaminants in the ground material can additionally occur when the polymer composition is transported to other companies for grinding and the mils used there are used in alternation for a wide variety of different materials.

There is therefore a high interest firstly in optimizing the handing of the polymer composition for use as a matrix polymer, but also the impregnation process, and also the consolidation that takes place in parallel or follows the impregnation in the process for producing semifinished fiber matrix products, especially those based on carbon fibers.

US 20141006018 A1 discloses a process for producing impregnated substances and composite articles, in which a fiber material is Impregnated with a polyamide composition in particle form, for example in the form of beads or microbeads, by partly melting the particles. In one embodiment, the polyamide composition may comprise a novolak resin.

DE 2558200 A1 describes a process for producing prepregs based on solvent-free, preferably thermoset synthetic resins. Consolidated structures made from textile materials based on melamine-formaldehyde resins, finally, are also known from EP 0 062 179 A1.

It was an object of the present invention to improve the powder impregnation process for production of semifinished fiber matrix products to the effect that the polymer composition required leads to minimum evolution of dust on application to the fiber material without impairing the impregnation operation or the consolidation in any way.

It was additionally an object of the present invention to improve the powder impregnation process for production of semifinished fiber matrix products so as to result in improved impregnation of the fibers and/or improved consolidation.

In a particularly preferred embodiment, it is to be possible to provide single-layer semifinished fiber matrix products in this way. This is because, according to WO 2008/058971 A1 and WO 2010/132 335 A1, the prior art processes lead to semifinished fiber matrix products which, on lateral viewing of a section cut through such a semifinished fiber matrix product, show a layered structure. There is a difference here between the matrix resin composition that encapsulates and embeds the semifinished textile product to form an interpenetrating network of fibrous material therewith and the surface resin composition. The latter is either free of fiber material or, as in WO 2010/132 335 A1, comprises a different polymer composition. The layered structure becomes particularly clear in WO 2012/132 399 A1, which distinguishes a surface resin composition and a matrix resin composition from one another within a semifinished fiber matrix product. Finally WO 2012/058 379 A1 also describes, in the examples section, the layered structure of composite materials composed of films.

But it is specifically a layered structure of semifinished fiber matrix products that can have an adverse effect on the stability of a product, as a result of the occurrence of delamination in the case of mechanical stress. Proceeding from this prior art, it was an object of the present invention to provide semifinished fiber matrix products that have no tendency, or at least a considerably reduced tendency, to delamination compared to the prior art, in addition to the objects already defined above.

An additional notable aspect of the property of having one layer for the purposes of the present invention is the interplay between the features of the semifinished fiber product laminas, the degree of impregnation the degree of consolidation, the fiber volume content, and the air or gas content. A characteristic feature is that the distribution gradient of the fiber content in a section through a single-layer semifinished fiber matrix product is virtually unchanged, and preferably changes by a maximum of 5%, preferably by a maximum of 3%, from the surface to the middle.

Impregnation is understood in accordance with the invention to mean the wetting of all fibers with the polymer composition. Consolidation refers to the expression of enclosed air. The procedures of impregnation and consolidation depend on parameters including temperature, pressure and time. Both properties, the degree of impregnation and the degree of consolidation, can be measured/checked by determination of mechanical indices in the semifinished fiber matrix product obtained, especially by measurement of the tensile strength of semifinished fiber matrix product test specimens. Tensile strength is determined using the tensile test, a quasistatic, destructive test method performed, in the case of plastics, according to ISO 527-4 or -5.

### INVENTION

The present invention provides an impregnation process for production of a semifinished fiber matrix product, comprising
a) providing at least one fiber material, preferably a fiber material comprising endless fibers,
b) providing a polymer composition in the form of a micropelletized material,
c) applying the micropelletized material to the fiber material,
d) impregnating and consolidating the fiber material with the polymer composition to give a composite by action of temperatures not less than the melting temperature of the at least one polymer and pressure on the fiber material that has been contacted with micropelletized material, and
e) cooling to obtain the composite structure,
   wherein a micropelletized material constitutes a pile of grains, the individual particles of which have greater or lesser homogeneity of grain size and are referred to as pellet grains or pellets, and these have a mean grain size, to be determined by means of dry sieve analysis according to DIN 53477, in the range from 0.01 to 3 mm.

Preferably, the present invention relates to an impregnation process for producing a single-layer semifinished fiber matrix product, comprising
a) providing a fiber material in the form of 1 to 100 semifinished fiber product laminas composed of endless fibers, preferably 2 to 40 semifinished fiber product laminas composed of endless fibers, more preferably 2 to 10 semifinished fiber product laminas composed of endless fibers, where the semifinished fiber product laminas each have a basis weight in the range from 5 g/m² to 3000 g/m², preferably in the range from 100 g/m² to 900 g/m², particularly preferably in the range from 150 g/m² to 750 g/m²,
b) providing a polymer composition in the form of a micropelletized material, where the polymer composition has a melt volume flow rate MVR to ISO 1133 In the range from 50 cm³/10 min to 500 cm³/10 min, more preferably in the range from 50 cm³/10 min to 300 cm³/10 min, most preferably in the range from 100 cm³/10 min to 200 cm³/10 min, at a load of 5 kg and a temperature of 260° C.,
c) applying the micropelletized material to the totality of all semifinished fiber product laminas,
d) impregnating and consolidating the totality of all semifinished fiber product laminas with the polymer composition to give a composite by action of temperatures not less than the melting temperature of the polymer composition and pressure on the totality of all semifinished fiber product laminas that has been contacted with micropelletized material,
e) cooling or solidification to obtain the composite structure with a proportion by volume of fiber materials, defined in accordance with DIN 1310, in the range from 25% to 65%, preferably in the range from 30% to 55%, more preferably in the range from 40% to 50%, and a proportion by volume of air or gas, to be determined by density determination according to DIN EN ISO 1183, of less than 10%, preferably less than 5%,
   wherein a micropelletized material constitutes a pile of grains, the individual particles of which have greater or lesser homogeneity of grain size and are referred to as pellet grains or pellets, and these have a mean grain size, to be determined by means of dry sieve analysis according to DIN 53477, in the range from 0.01 to 3 mm.

By exposing at least one fiber material comprising a polymer composition in the form of a micropelletized material to heat and pressure, impregnation is effected, with subsequent or else simultaneous consolidation of the fibers with the polymer composition to be used, giving a semifinished fiber matrix product in the form of a composite structure with avoidance of the abovementioned disadvantages.

It should be noted for the avoidance of doubt that al below-referenced definitions and parameters referred to in general terms or within preferred ranges in any desired combinations are encompassed. Standards cited in the context of this application are considered to mean the version in force at the filing date of this application. A polymer composition in the context of the present invention is a composition comprising at least one polymer.

According to the invention, it is alternatively possible to produce composite structures that have been overmolded or insert-molded with injection molding compounds, by attaching reinforcements, preferably reinforcement structures in the form of fins, or functional elements to the composite structure by injection molding either during the consolidation or in an additional process step.

### Definitions of Terms

The person skilled in the art understands a pelletized/micropelletized material to mean a pile of grains, the individual particles of which have greater or lesser homogeneity of grain size and are referred to as pellet grains or pellets. While the umbrella term “pelletized material” refers to mean grain sizes in the range from 0.1 to 50 mm, the term “micropelletized material”—as also in the context of the present invention—is used for mean grain sizes in the range from 0.01 to 3 mm. The term “pelletized material” or “micropelletized material” relates to the shape and size of the end product and not to the production method therefor. Even smaller particles are referred to as dusts and are defined in EN 481. By comparison with ground powders, no dust forms in the case of micropelletized material, electrostatic charges are minimized, and the risk of explosions in the course of processing is considerably reduced. Micropelletized materials can be conveyed by means of suction devices and contribute to more rapid filling of the mold intended for processing and hence to a reduction in costs in production processes.

In the context of the present invention, the melt volume flow rate MVR according to ISO 1133 is determined by means of a capillary rheometer, the material (pellets or powder) being melted in a heatable cylinder and forced through a defined nozzle (capillary) under a pressure resulting from the applied load. A determination is made of the emerging volume/mass of the polymer melt—called the extrudate—as a function of time. A key advantage of the melt volume flow rate is the simplicity of measuring the piston travel for a known piston diameter to determine the volume of melt that has emerged. The unit for MVR is cm³/10 min.

The terms “above”, “at” or “approximately” used in the present description are to be understood as meaning that the magnitude or value that follows may be the specific value or a value that is approximately equal. The term is intended to convey that similar values lead to results or effects that are equivalent according to the invention and are encompassed by the invention.

A “fiber” in the context of the present invention is a macroscopically homogeneous body having a high ratio of length to cross-sectional area. The fiber cross section may be any desired shape but is generally round or oval.

According to “http://de.wikipedia.org/wiki/Faser-Kunstoff-Verbund”, a distinction is made between chopped fibers, also known as short fibers, having a length in the range from 0.1 to 1 mm, long fibers having a length in the range from 1 to 50 mm, and endless fibers having a length L>50 mm. Fiber lengths can be determined, for example, by microfocus x-ray computed tomography (μ-CT); DGZfP [German Society for Non-Destructive Testing] annual conference 2007—lecture 47.

Semifinished fiber matrix products to be produced in accordance with the invention contain endless fibers. In one embodiment, they may additionally also contain long fibers. Endless fibers are used in the form of rovings or weaves, and achieve the highest stiffness and strength values in the products to be produced therefrom. The term “fiber material” used in the context of the present application means either a material in the form of a semifinished fiber product which is preferably selected from the group of weaves, laid scrims including multiaxial laid scrims, knits, braids, nonwovens, felts and mats, or else the fiber material comprises unidirectional fiber strands. In addition, “fiber material” means a mixture or a combination of two or more of said semifinished fiber products or unidirectional fiber strands.

For production of semifinished fiber products, the fibers to be used are bonded to one another in such a way that at least one fiber or a fiber strand is in contact with at least one other fiber or other fiber strand in order to form a continuous material. Alternatively, the fibers used for production of semifinished fiber products are in contact with one another so as to form a continuous mat, weave, textile or similar structure.

The term “basis weight” describes the mass of a material as a function of its area, and in the context of the present invention relates to the dry fiber layer. The basis weight is determined according to DIN EN ISO 12127.

The thread count in a fiber bundle or cable is useful in the definition of a carbon fiber size. Standard sizes are 12 000 (12 k) filaments per fiber bundle or 50 000 (50 k) filaments per fiber bundle. The thread count is determined according to DIN EN 1049-2/ISO 7211-2.

“Impregnated” in the context of the present invention means that the polymer composition penetrates into the depressions and cavities of the fiber material/semifinished fiber product and wets the fiber material. “Consolidated” in the context of the present invention means that an air content of less than 10% by volume is present in the composite structure. Impregnation (wetting of the fiber material by the polymer composition) and consolidation (minimizing the proportion of enclosed gases) can be effected and/or performed simultaneously and/or consecutively.

### Process Step a)

The fiber material to be provided in process step a) is a fiber material comprising endless fibers. Preferably, the term “fiber material” encompasses the totality of all semifinished fiber product laminas composed of endless fibers. In one embodiment, the fiber material for use in accordance with the invention, in addition to the endless fibers, may also contain long fibers having lengths in the range from 1 to 50 mm.

Preferably, the fiber material for use in accordance with the invention does not contain any comminuted fibers or particles, and especially does not contain any short fibers having a length in the range from 0.1 to 1 mm.

According to the invention, the fiber material should preferably be used in the form of a semifinished fiber product or In the form of unidirectional fiber strands. Preferred semifinished fiber products are woven or nonwoven structures. Preferably, at least one semifinished fiber product from the group of weaves, laid scrims including multiaxial laid scrims, knits, braids, nonwovens, felts, mats, a mixture of two or more of these materials, and combinations thereof is used.

Nonwovens may be used with random fiber alignment or with aligned fiber structures. Random fiber orientations are preferably found in mats, in needled mats or in the form of felt. Aligned fibrous structures are preferably found in unidirectional fiber strands, bidirectional fiber strands, multidirectional fiber strands, multiaxial textiles. Preferably, the fiber material to be used is a unidirectional laid scrim or a weave.

Preference is given to using fiber materials composed of glass fibers and/or carbon fibers, more preferably composed of glass fibers.

Preferably, the fiber material composed of carbon fibers is a weave having a basis weight of not less than 150 g/m².

Preferably, the fiber material composed of glass fibers is a weave. Preferably, the fiber material composed of glass fibers has a basis weight of not less than 200 g/m², more preferably not less than 300 g/m².

In one embodiment of the invention, combinations of fiber material composed of carbon fibers and fiber material composed of glass fibers are used. Preference is given to fiber material combinations or semifinished fiber products containing carbon fibers in the outer laminas and glass fibers in at least one inner lamina.

Preferably, a semifinished fiber matrix product to be produced in accordance with the invention comprises two or more layers of fiber materials which are impregnated with one or more polymer compositions in micropelletized form.

Preferably, the content of fiber materials in the semifinished fiber matrix product to be produced in accordance with the invention is in the range from 40 to 75 percent by weight, more preferably in the range from 65 to 75 percent by weight.

### Process Step b)

Preferably, the at least one polymer in the polymer composition is a thermoplastic. More preferably, the polymer composition to be provided in process step b) comprises at least one thermoplastic from the group of polyamide (PA), polycarbonate (PC), thermoplastic polyurethane (TPU), polybutylene terephthalate (PBT), polyphenylene sulfide (PPS), polyphthalamide (PPA), polypropylene (PP), polyethylene terephthalate (PET), polyethylene (PE), polylactic acids (PLA), acrylonitrile-butadiene-styrene (ABS), styrene-acrylonitrile (SAN), polyether ether ketone (PEEK), polyether imide (PEI), polyesther sulfone (PES), polymethylmethacrylate (PMMA), polyoxymethylene (POM) and polystyrene (PS), and derivatives and blends thereof.

Most preferably, the polymer composition comprises at least one thermoplastic from the group of polyamide (PA), polycarbonate (PC), thermoplastic polyurethane (TPU), polybutylene terephthalate (PBT), polypropylene (PP), polyethylene terephthalate (PET) and polyethylene (PE), and derivatives and blends thereof.

Especially preferably, the polymer composition comprises at least one thermoplastic from the group of polypropylene (PP), polyamide (PA), polycarbonate (PC), polybutylene terephthalate (PBT) and polyethylene terephthalate (PET), and derivatives and blends thereof.

Preferably, a polymer composition composed of at least PA is used. PA can be synthesized from different synthesis units and produced by various methods and, in a specific application scenario, can be modified, alone or in combination, with processing aids, stabilizers, polymeric alloying components (e.g. elastomers) or else reinforcing materials (such as mineral filers or glass fibers, for example) and optionally further additives, to give materials having tailored combinations of properties. Also suitable are PA blends having proportions of other polymers, preferably of polyethylene, polypropylene, ABS, wherein one or more compatibilizers may optionally be employed. The properties of the polyamides may be improved as required by addition of elastomers.

A multiplicity of procedures for producing PA have become known and depending on the desired end product different monomer units or various chain transfer agents are used to establish a target molecular weight or else monomers having reactive groups for subsequently intended aftertreatments are used.

PA to be used with preference is produced by polycondensation in the melt, wherein in the context of the present invention the hydrolytic polymerization of lactams is also to be understood as being a polycondensation.

PA preferred for use in accordance with the invention derives from diamines and dicarboxylic acids and/or lactams having at least 5 ring members or corresponding amino acids. Preferably contemplated reactants are aliphatic and/or aromatic dicarboxylic acids, particularly preferably adipic acid, 2,2,4-trimethyladipic acid, 2,4,4-trimethyladipic acid, azelaic acid, sebacic add, isophthalic acid, terephthalic acid, aliphatic and/or aromatic diamines, particularly preferably tetramethylenediamine, hexamethylenediamine, nonane-1,9-diamine, 2,2,4- and 2,4,4-trimethylhexamethylenediamine, the isomeric diaminodicyclohexylmethanes, diaminodicyclohexylpropanes, bis(aminomethyl)cyclohexane, phenylenediamines, xylylenediamines, aminocarboxylic acids, in particular aminocaproic acid, or the corresponding lactams. Copolyamides of a plurality of the recited monomers are included.

Particular preference is given to employing PA composed of lactams, very particular preference being given to caprolactams, especial preference being given to ε-caprolactam.

Also employable in accordance with the invention is PA produced by activated anionic polymerization or copolyamide produced by activated anionic polymerization having polycaprolactam as the main constituent. Activated anionic polymerization of lactams to afford polyamides is performed on an industrial scale by producing firstly a solution of catalyst in lactam, optionally together with impact modifier, and secondly a solution of activator in lactam, wherein typically both solutions have a composition such that combination in the same ratio affords the desired overall recipe. Further additives may optionally be added to the lactam melt. Polymerization is effected by mixing the individual solutions to afford the overall recipe at temperatures in the range from 80° C. to 200° C., preferably at temperatures in the range from 100° C. to 140° C. Suitable lactams include cyclic lactams having 6 to 12 carbon atoms, preferably laurolactam or ε-caprolactam, particularly preferably ε-caprolactam. The catalyst is an alkali metal or alkaline earth metal lactamate, preferably in the form of a solution in lactam, particularly preferably sodium caprolactamate in ε-caprolactam. Activators in the context of the present invention that may be employed include N-acyl lactams or acid chlorides or, preferably, aliphatic isocyanates, particularly preferably oligomers of hexamethylene disocyanate. Activator may be used as pure substance and, preferably, as a solution, preferably in N-methylpyrrolidone.

Particularly suitable polyamides are those having a relative solution viscosity in m-cresol in the range from 2.0 to 4.0, preferably in the range from 2.2 to 3.5, very particularly in the range from 2.4 to 3.1. Measurement of the relative solution viscosity ηᵣₑₗ is effected according to EN ISO 307. The ratio of the efflux time t of the polyamide dissolved in m-cresol to the efflux time t (0) of the solvent m-cresol at 25° C. gives the relative solution viscosity in accordance with the formula ηᵣₑₗ=t/t(0).

Particularly suitable polyamides are additionally those having a number of amino end groups in the range from 25 to 90 mmol/kg, preferably in the range from 30 to 70 mmol/kg, very particularly in the range from 35 to 60 mmol/kg.

Very particular preference is given to using semicrystalline polyamides or compounds based thereon as polymer composition. According to DE 10 2011 064 519 A1 semicrystalline polyamides have an enthalpy of fusion in the range from 4 to 25 J/g measured by the DSC method to ISO 11357 in the 2nd heating and integration of the melt peak. In contrast, amorphous polyamides have an enthalpy of fusion of less than 4 J/g, measured by the DSC method to ISO 11357 n the 2nd heating and integration of the melt peak.

The use of nylon-6 [CAS No. 25038-54-4] or nylon-6,6 [CAS No. 32131-17-2] is especially preferred. The use of nylon-6 is very especially preferred. Nylon-6 or nylon-6,6 for use in accordance with the invention is available, for example, from Lanxess Deutschland GmbH, Cologne, under the Durethan® name. The nomenclature of the polyamides used in the context of the present application corresponds to the international standard EN ISO 1874-1:2010, the first figure(s) giving the number of carbon atoms in the starting diamine and the last figure(s) the number of carbon atoms in the dicarboxylic acid. If only one figure is stated, as in the case of nylon-6, this means that the starting material was an α,ω-aminocarboxylic acid or the lactam derived therefrom, i.e. ε-caprolactam in the case of nylon-6.

Preference is given to using a polymer composition composed of at least PC. Particular preference is given to using polycarbonates based on 2,2-bis(4-hydroxyphenyl)propane (bisphenol A), bis(4-hydroxyphenyl) sulfone (bisphenol S), dihydroxydiphenyl sulfide, tetramethylbisphenol A, 1,1-bis(4-hydroxyphenyl)-3,3,5-trimethylcyclohexane (BPTMC) or 1,1,1-tris(4-hydroxyphenyl)ethane (THPE). The use of PC based on bisphenol A is especially preferred. PC for use in accordance with the invention is available, for example, under the Makrolon® name from Covestro AG, Leverkusen.

Preference is given to using a polymer composition composed of at least TPU. Thermoplastic elastomers (occasionally also called elastoplasts (TPE)) are polymers for use in accordance with the invention that behave in a comparable manner to the conventional elastomers at room temperature, but can be plastically deformed with supply of heat and thus exhibit thermoplastic characteristics. A distinction is made between two TPU types: polyester-based TPUs derived from adipic esters and polyether-based TPUs derived from tetrahydrofuran ethers. Preference is given to using polyester-based TPUs.

Preference is given to using a polymer composition composed of at least PBT [CAS No. 24968-12-5]. PBT forms through polycondensation of the bis(4-hydroxybutyl) terephthalate intermediate. The latter can be prepared by esterification of butane-1,4-diol and terephthalic acid or by catalytic transesterificatlon of dimethyl terephthalate with butane-1,4-diol in the presence of transesterification catalysts, for example tetraisopropyl titanate. PBT for use with particular preference contains at least 80 mol %, preferably at least 90 mol %, based on the dicarboxylic acid, of terephthalic acid residues and at least 80 mol %, preferably at least 90 mol %, based on the diol component, of butane-1,4-diol glycol residues. PBT for use in accordance with the invention is available, for example, under the Pocan® name from Lanxess Deutschland GmbH, Cologne.

Preference is given to using a polymer composition composed of at least PPS. PPS [CAS No. 26125-40-6 or 25212-74-2] is a thermoplastic polymer of high thermal stability that has the general formula (SC₆Hₕ)ₙ. It is usually prepared industrially by polycondensation of 1,4-dichlorobenzene with sodium sulfide in aprotic solvents such as N-methylpyrrolidone.

Preference is given to using a polymer composition composed of at least PPA. PPAs are aromatic polyamides that are generally used only in modified (reinforced or filled) form. They form part of the class of the thermoplastics. Monomers used for preparation of polyphthalamides are diamines of different chain length and the aromatic dicarboxylic acid terephthalic acid. With elimination of water, these monomers polycondense to give the polymer.

Preference is given to using a polymer composition composed of at least PP. PP [CAS No. 9003-07-0] is a semicrystalline thermoplastic and forms part of the group of the polyolefins. Polypropylene is obtained by polymerization of the monomer propene with the aid of catalysts.

Preference is given to using a polymer composition composed of at least PET. PET [CAS No. 25038-59-9] is a thermoplastic polymer, prepared by polycondensation, from the family of the polyesters based on the monomers ethylene glycol and terephthalic acid. PET for use with particular preference contains at least 80 mol %, preferably at least 90 mol %, based on the dicarboxylic add, of terephthalic acid residues and at least 80 mol %, preferably at least 90 mol %, based on the diol component, of ethylene glycol residues.

Preference is given to using a polymer composition composed of at least PE. Polyethylene [CAS No. 9002-88-4] is a semicrystalline and nonpolar thermoplastic. It is possible via the choice of polymerization conditions to adjust the molar mass, molar mass distribution, mean chain length and degree of branching. On the basis of the different density, a distinction is made between four main types, although the abbreviations are not always used uniformly:
high-density polyethylene, PE-HD or HDPE
medium-density polyethylene, PE-MD or MDPE
low-density polyethylene, PE-LD or LDPE
linear low-density polyethylene, PE-LLD or LLDPE.

Very particular preference is given in accordance with the invention to HDPE or LDPE.

Preference is given to using a polymer composition composed of at least PLA. Polylactides [CAS No. 26100-51-6] are synthetic polymers that are among the polyesters and are obtainable by the ionic polymerization of lactide, a cyclic combination of two lactic acid molecules. They are formed from many lactic acid molecules chemically bound to one another.

Preference is given to using a polymer composition composed of at least ABS. ABS [CAS No. 9003-56-9] is a synthetic terpolymer composed of the three different monomer types acrylonitrile, 1,3-butadiene and styrene and is among the amorphous thermoplastics. Preferably, the ratios of amounts in the ABS vary within the range of 15%-35% by weight of acrylonitrile, 5%-30% by weight of butadiene and 40%-60% by weight of styrene.

Preference is given to using a polymer composition composed of at least SAN. SAN [CAS No. 9003-54-7], being a copolymer of styrene and acrylonitrile, is similar to polystyrene in terms of structure and properties. Preferably, SAN has a styrene content in the range from 65% to 81% by weight and an acrylonitrile content in the range from 19% to 35% by weight. Particular preference is given to a styrene content of 70% by weight and an acrylonitrile content of 30% by weight.

Preference is given to using a polymer composition composed of at least PEEK. PEEK [CAS No. 29658-26-2] is a thermoplastic polymer of high thermal stability and forms part of the group of the polyaryl ether ketones. Its melting temperature is 335° C. PEEK polymers arise from alkylation of bisphenol salts. Most preferably, PEEK is based on the reaction of 4,4′-difluorobenzophenone and hydroquinone salt.

Preference is given to using a polymer composition composed of at least PEI. PEI [CAS No. 61128-46-9] is prepared by polycondensation of bisphthalic anhydride and 1,3-diaminobenzene or N-phenyl-4-nitrophthalimide and the disodium salt of bisphenol A.

Preference is given to using a polymer composition composed of at least PES. Polyether sulfone [CAS No. 2560863-3] is an amorphous, transparent high-performance polymer with slightly brownish transparency. The synthesis of poly(oxy-1,4-phenylsulfonyl-1,4-phenyl) can proceed either via a polysulfonylation or via a polyether synthesis.

Preference is given to using a polymer composition composed of at least PMMA. PMMA [CAS No. 9011-14-7] is routinely prepared by free-radical means via emulsion, solution and bulk polymerization. PMMA produced in such a way is atactic and completely amorphous. Anionic polymerization of PMMA is likewise possible.

Preference is given to using a polymer composition composed of at least POM. In the case of POM [CAS No. 9002-81-7], a distinction is made between the homo- and copolymer, which are prepared by different methods. The homopolymer (also referred to as POM-H) has the structure —(CH₂—O—)ₙ and differs essentially by the degree of polymerization of paraformaldehyde and is usually obtained by direct polymerization of formaldehyde. The copolymer, also referred to as POM-C, has the structure —[(CH₂—O)ₙ—(CH₂—CH₂—O—)ₘ], and is obtained by copolymerization of trioxane with 1,4-dioxane.

Preference is given to using a polymer composition composed of at least PS. PS [CAS No. 9003-53-6] is a transparent amorphous or semicrystalline thermoplastic which is white when foamed, and which is obtained by polymerization of monomeric styrene.

The polymer composition for use in accordance with the invention preferably comprises at least one addition or additive, more preferably at least one additive from the group of ultraviolet light stabilizers, flame retardants, leveling-promoting additives, lubricants, antistats, colorants, preferably dyes, pigments, carbon black, nucleators, crystallization promoters, fillers and other processing auxiliaries or mixtures thereof. These additives and other constituents can be used in amounts and in forms as commonly known to the person skilled in the art, including in the form of what are called nano-materials in which at least one dimension of the particles is in the range from 1 to 1000 nm. Preferably, in the with the at least one polymer in the polymer composition, fillers are used, especially short glass fibers.

Preferably, the additives are dispersed in the thermoplastic of the polymer composition. The dispersing is preferably effected by means of a melt mixing process. Mixing apparatuses to be used for such a melt mixing process are preferably single- or twin-screw extruders or Banbury mixers. The additives are mixed either all at once in a single stage or stepwise and then in the melt. In the case of stepwise addition of the additives to the at least one polymer, a portion of the additives is first added to the polymer and mixed in the melt. Further additives are then added and the mixture is mixed until a homogeneous composition is obtained.

More preferably, the additives are dispersed and compounded in the thermoplastic in an upstream step. Compounding is a term from the plastics industry, synonymous with plastics processing, that describes the process of upgrading plastics by mixing in admixtures (fillers, additives etc.) for specific optimization of the profiles of properties. Compounding is preferably effected in extruders and comprises the process operations of conveying, melting, dispersing, mixing, degassing and pressure buildup. Dispersing is preferably effected by means of a melt-mixing process in at least one mixing tool. Mixing tools are preferably single- or twin-screw extruders or Banbury mixers. The individual components of the polymer composition are mixed in at least one mixing tool, preferably at temperatures in the region of the melting point of the at least one polymer in the polymer composition, and discharged in strand form. Typically, the strand is cooled down until pelletizable and then pelletized.

According to the invention, the polymer composition is used in micropelletized form. By contrast with the prior art, the use of a polymer composition in the form of ground powder, it is possible in the case of micropellets to dispense with an upstream processing step, namely the grinding of the polymer composition. Prior to the grinding, the polymer composition is generally in the form of pellets, flakes or other macroscopic pieces. The grinding produces heat, and this in turn causes the grinding material to stick and conglutinate in the mill. In the prior art, this is remedied by conducting the grinding at low temperatures, in the form of cryogenic grinding. The cooling required for the purpose and the additional grinding step itself make the process for producing semifinished fiber matrix products more costly and lead to further drawbacks.

### Micropelletized Material

A micropelletized material in the context of the present invention preferably has a mean grain size in the range from 0.01 to 3 mm, more preferably in the range from 0.1 to 2 mm and most preferably in the range from 0.2 to 1.2 mm, where mean grain size means that the sum total of the proportions by mass of the grain fractions having grain sizes greater than the mean grain size is 50%. Correspondingly, the sum total of the proportions by mass of the grain fractions having grain sizes smaller than or equal to the mean grain size is likewise 50%. The grain sizes are determined by dry sieve analysis according to DIN 53477. The amount of sieving material is preferably 100 g each time. The grain size stated is understood to mean the equivalent diameter of the spheres of equal volume, and this corresponds to the nominal size of the analysis sieve opening. By way of example, it is possible to use corresponding sieving machines from Karg Industrietechnik (Krailing).

The micropelletized materials preferably have the same shape. In one embodiment, it is possible to use a mixture composed of two or more, for example three or four, micropelletized materials which differ from one another in relation to their shape. The micropelletized materials may, for example, be spherical or ellipsoidal (lens-shaped), cubic or cylindrical. It is also possible to use mixtures where the micropelletized materials are of different molding compounds and/or different grain sizes and/or different distribution breadths of the grain sizes and differ from one another in shape.

Preferably, micropelletized materials for use in accordance with the invention have a cylindrical shape. The ratio of cylinder height to cylinder diameter is preferably in the range from 10 to 0.5, more preferably in the range from 5 to 1.

Preferably, however, micropelletized materials for use in accordance with the invention also have a spheroidal or ellipsoidal shape.

Micropelletized materials for use in accordance with the invention can have a wide variety of different bulk densities. Preference is given to using micropelletized materials having bulk densities in the range from 200 to 1800 g/l, more preferably in the range from 500 to 1000 g/l. The bulk density is determined by filing a measuring cylinder with the micropelletized material at room temperature up to one liter and then weighing this volume of micropelletized material. Bulk densities are determined in the context of the present invention according to EN ISO 60, preferably with an SMG 697 bulk density measuring instrument from Powtec Maschinen & Engineering GmbH, Remscheld.

Micropelletized materials for use in accordance with the invention are preferably produced from the melt of the polymer composition: After the polymerization, compounding or melting, the plastic in the extruder is at first in molten form. In a preferred process, said melt is shaped by means of dies to give strands and chilled in air or water. In a particularly preferred process, subsequently, a rotating blade cuts the strands into short sections that are then in the form of micropellets. The latter can then be transported in pipelines or packed in sacks or other containers. In another preferred process, small droplets are formed from the melt, which then cool and solidify.

The polymer compositions for use for the micropelletized materials may comprise at least one addition. Either at least one addition is added in the course of the melting for the micropelletization or else the at least one addition is already added in the course of production of the polymer composition. It is likewise possible for a portion of the additions to be added during the production of the polymers, and for a further portion of the additions to be incorporated later. The incorporation of at least one addition and/or the production of the polymer composition by mixing of different polymers can be effected, for example, above the softening temperature thereof and in customary mixing apparatuses such as extruders or kneaders. Subsequently, the plastified polymer composition as molding compound is forced through at least one die or die plate. The die has, or the bores of the die plate have, a diameter corresponding to or less than the later diameter of the micropelletized material. In general, the die has or the bores have a diameter less than the diameter of the micropelletized material. Preferably, the ratio of die diameter or bore diameter to diameter of the micropelletized material s in the range from 0.5:1 to 0.8:1. Preferably, the output from the die or from the die plate is pelletized under water or under air. The temperature of the melt of the polymer composition on discharge is in the region of the melting point of the at least one polymer or somewhat higher. It is also possible to discharge one strand, a plurality of strands or a multitude of strands simultaneously, to cool them in water and then to divide them into the micropellets.

Micropellets for use in accordance with the invention are preferably produced directly from the melt obtained in the production of the polymer composition. In this way, an additional pelletization and remelting operation is avoided.

The micropellets for use in accordance with the invention generally have very small residual contents of evaporable monomers originating from the production of the molding compound from the polymer composition.

For use in the process of the invention, the micropellets generally contain only a low residual moisture content. Preferably, the residual water content is not more than 0.3% by weight, more preferably not more than 0.2% by weight, especially not more than 0.1% by weight, based in each case on the total weight. The residual water content is determined here by means of a thermal balance, for example Sartorius MA 30, using samples having a weight in the range from about 1 to 5 g, by determining the starting weight of the samples, drying the samples at 160° C. for a duration of 20 minutes, and determining the loss of weight.

Preferably, micropellets for use in accordance with the invention have a Shore A hardness of more than 90° and a Shore D hardness of more than 60°. The Shore hardness is determined according to DIN 43505 with test instrument A or test instrument D.

In the case of an embodiment in which the micropellets in top view have a circular cross section, at least 90% of the micropellets for use in accordance with the invention have a contour angle >90°, more preferably >105°, especially preferably >120°, where the geometry is determined by two-dimensional evaluation in the form of a graph using microscope images of the micropellets. The maximum deviation from the ideal geometry is determined by approximating and measuring regions in which the particle contour is very uneven by means of suitable chords. By definition, in the event of a deviation in the angle α formed by two chords of <162°, there is no longer an ideal circular shape. The choice of suitable chord length s is made via the unit circle with radius r=1. The circle is divided into 20 segments of equal size, such that each element corresponds to a circle segment of 18° (360°:20). s=r*sin(α)/cos(α/2) with α=18° and r=D/2 give s=D* 0.156, where D corresponds to the maximum particle diameter or the maximum particle extent. Preferably, micropellets for use in accordance with the invention are produced by underwater pelletization, with prior blending and mixing of the polymer composition at melting temperature in a compounding unit, preferably a twin-screw extruder (ZSK). At the exit of the compounding unit, there is a die plate or hole plate through which the molten polymer formulation is forced, and it solidifies in the water bath beyond and is processed by rotating blades. The size of the microparticles is dependent on the choice of die/hole plate and on the speed, and hence on the cutting frequency of the rotating blades. The choice of suitable cutting frequency or speed of the rotating blades and cutting blades, the size and number of bores in the die/hole plate, the water temperature and processing temperature and the throughput rate of the polymer formulation will be adjusted with regard to the thermoplastic to be used in each case by the person skilled in the art. Process systems suitable in accordance with the invention for micropelletized material technology are available from Gala Industries Inc., Eagle Rock, Va., USA (June 2013 product brochure).

### Process Step c)

Application of the micropelletized material to the fiber materials in process step c) is effected by conventional means, preferably by scattering, trickling, printing, spraying, irrigating, thermal spraying or flame spraying, or by fluidized bed coating processes. In one embodiment multiple layers of micropellets can be applied to the fiber material.

The micropelletized material is preferably applied to the fiber materials in amounts so as to result in a proportion by volume of fiber materials, defined according to DIN 1310, in the semifinished fiber matrix product in the range from 25% to 80%, more preferably in the range from 40% to 60%.

In one embodiment, the application may be followed by a sintering step in which the micropelletized material on the fiber material is sintered. The sintering, optionally under pressure, heats the micropelletized material, but the temperature remains below the melting temperature of the polymer to be used in each case. This generally results in shrinkage because the micropellet particles of the starting material increase in density, and pore spaces in the fiber material are filled.

Subsequently, the micropellet-coated fiber materials in process step d) are subjected to the influence of pressure and temperature. This is preferably done by preheating the micropelet-coated fiber materials outside the pressure zone.

### Process Step d)

In process step d), the fiber material that has been coated with micropelletized material is heated in order to initiate the complete impregnation and the subsequent consolidation of the fiber material. In addition, pressure is applied.

As a result of the influence of pressure and heat, the at least one polymer in the polymer composition or the polymer formulation melts and penetrates the fiber materials that it thus impregnates. As a result of escape of existing gas or gas which forms from the cavities between the fiber material and the polymer composition, the consolidation takes place. The gases contain gas from the environment (e.g. air or nitrogen) and/or water/steam and/or thermal breakdown products of the at least one polymer to be used.

Preference is given to employing, in process step d), a pressure in the range from 2 to 100 bar, more preferably in the range from 10 to 40 bar.

The temperature to be employed in process step d) is not less than the melting temperature of the at least one polymer to be used or of the polymer composition. In one embodiment, the temperature to be employed is at least 10° C. above the melting temperature of the at least one polymer to be used. In a further embodiment, the temperature to be employed is at least 20° C. above the melting temperature of the at least one polymer to be used. Heating may be effected by a great many means, preferably contact heating, radiative gas heating, infrared heating, convection or forced convection, induction heating, microwave heating or combinations thereof. Consolidation follows immediately thereafter.

The processes of impregnation and consolidation depend in particular on the parameters of temperature and pressure. In one embodiment, the pressure to be employed is additionally dependent on time.

Preference is given to employing the stated parameters until the semifinished fiber matrix product has a cavity content of less than 5% —this means the proportion by volume of air or gas. The aim here is more preferably that the cavity content is less than 5% within a period of less than 10 minutes at temperatures above 100° C., more preferably at temperatures in the range from 100° C. to 350° C. It is preferable to employ pressures above 20 bar.

The application of pressure may be effected via a static process or via a continuous process (also known as a dynamic process), a continuous process being preferred for reasons of speed. The person skilled in the art will draw a distinction in the production of thermoplastic semifinished fiber composite sheet products (FKV), depending on the material throughputs to be achieved, between the film stacking, prepreg and direct process types. Preferably, the impregnation process of the invention, with regard to high material throughput, is conducted by the direct process in which the matrix component and the textile component are bought together directly in the region of the material feed to the pressing process. Preferably, the direct process is a semicontinuous or continuous operation, more preferably a continuous operation.

Preferably, it is an impregnation process from the group—without limitation—of vacuum forming, coating in a mold, transverse die extrusion, pultrusion, lamination, embossing, membrane forming, compression molding. Preference is given in accordance with the invention to lamination.

Preferred lamination techniques include, without limitation, calendering, flat bed lamination and twin belt press lamination. When lamination is used as the impregnation process, it is preferable to use a cooled twin belt press (see also EP 0 485 895 B1).

In one embodiment, in process step d), the composite structure can be formed to a desired geometry or configuration by means of a shaping process to be employed simultaneously. Preferred shaping processes for geometric configuration of the composite structure are compression molding, stamping, pressing or any process using heat and/or pressure. Particular preference is given to pressing and stamping. In the shaping process, pressure is preferably applied by the use of a hydraulic compression mold. In the pressing or stamping operation, the composite structure is preheated to a temperature above the melting temperature of the at least one polymer in the polymer composition and converted to the desired shape or geometry with a molding device or a mold, especially at least one compression mold.

For achievement of optimal mechanical properties, maximum impregnation of the filaments of the fiber material with the at least one polymer or the polymer composition is desirable. It has been found that, in the presence of fiber material composed of glass fibers, there is a rapid impregnation rate of fiber material composed of carbon fibers, which leads to a quicker overall production cycle overall for semifinished fiber matrix products that contain both glass fibers and carbon fibers.

At the same time as the impregnation or after the impregnation, consolidation takes place, which is understood to mean the expression of enclosed air and other gases. Consolidation is especially also dependent on the parameters of temperature and pressure, and additionally on the parameter of time, i.e. the duration over which pressure and temperature are applied to polymer composition and semifinished fiber product.

The principle of impregnation consists in the impregnation of a dry fiber structure with a matrix composed of polymer or polymer formulation that has been provided beforehand as a micropelletized material in accordance with the invention. The flow through the semifinished fiber product is comparable with the flow of an incompressible fluid through a porous base medium. The flow is described using the Navier-Stokes equation:

$$ρ \frac{dv}{dt} = - ∇ P + η {∇}^{2} v$$

in which ρ is the density, ν the velocity vector, ∇P the pressure gradient and q the viscosity of the fluid used. If it is assumed that the flow velocity of the polymer or the polymer formulation—also referred to as the matrix—in the reinforcing structure can be classified as low, the inertia forces in the above equation (the left-hand side thereof) can be neglected. The equation is accordingly simplified to the form known as the Stokes equation:

0=−∇P+η∇²ν

Both properties, the degree of impregnation and the degree of consolidation, can be measured/checked by determination of mechanical indices, in particular by measurement of the tensile strength in composite structure test specimens. Tensile strength is determined using the tensile test, a quasistatic, destructive test method performed, in the case of plastics, according to ISO 527-4 or -5.

In the fully impregnated and fully consolidated form, the fibers in the fiber material used fulfill the task of imparting strength and stiffness to the composite structure to be produced, whereas the matrix composed of at least one polymer or the polymer composition, as compared with the comparatively brittle fibers, has a positive effect on the elongation at break of the composite structure. The different orientation of the fibers, for example in the form of a weave, can counteract specific load scenarios (anisotropy). Isotropy can be achieved, for example, through the use of a random fiber web.

Since both the impregnation operation and the consolidation operation are dependent on the parameters of temperature and pressure, those skilled in the art will adapt these parameters to the polymer to be used in each case or the polymer composition. Those skilled in the art will also adapt the duration over which the pressure and temperature are applied according to the polymer to be used or the polymer composition.

### Process Step e)

After the consolidation, the fiber composite structure obtained in process step d) is allowed to cool down to a temperature below the melting temperature of the matrix resin (=polymer) or the matrix resin composition (=polymer composition), also referred to as solidification, and the fiber composite structure is removed from the press in the form of a semifinished fiber matrix product of the invention. The term “solidification” describes the setting of the mixture of fiber structure and liquid matrix through cooling or through chemical crosslinking to afford a solid body. Preferably, the single-layer semifinished fiber matrix product of the invention, in the case of use of a twin belt press, occurs in the form of sheet material.

If there was simultaneous shaping, the cooling to a temperature below the melting temperature of the matrix resin or the matrix resin composition, preferably to room temperature (23+/−2° C.), is followed by removal of the fiber composite structure from the mold.

In the production of thermoplastic semifinished fiber composite sheet products such as the semifinished fiber matrix products of the invention, depending on the material throughputs to be achieved, a distinction is made between film stacking, prepreg and direct processes. For a high material throughput in the case of direct processes, the matrix component and the textile component are brought together directly in the region of the material feed to the pressing process. This is generally associated with high plant complexity. In addition to the prepreg processes the film stacking process is often used for small to medium amounts. Here, a construct consisting of alternatingly arranged film and textile laminas passes through the pressing process. The nature of the pressing process is determined by the required material output and the material diversity. A distinction is made here in order of increasing material throughput between static, semicontinuous and continuous processes. Plant complexity and plant costs rise with increasing material throughput (AKV—Industrievereinigung Verstärkte Kunstatoffe e.V., Handbuch Faserverbund-Kunstatoffe, 3rd edition, 2010, Vieweg-Teubner, 236).

The impregnation process of the invention is of particularly good suitability for semicontinuous or continuous pressing processes, preferably in twin belt presses or in continuous compression molds. The impregnation process of the invention is notable for rapid impregnation and high productivity and makes it possible to produce fiber composite structures at high rates and with a low proportion of pores or air inclusions.

Preferably, a semifinished fiber matrix product of the invention, i.e. the composite structure obtained after process step e), has just one layer in which the fibers or the fiber material is/are in a form impregnated and consolidated with the polymer composition, also referred to in accordance with the invention as single-layer semifinished fiber matrix product.

The invention therefore also relates to a single-layer semifinished fiber matrix product wherein the latter is obtained by
a. providing at least one fiber material,
b. providing a polymer composition in the form of a micropelletized material,
c. applying the micropelletized material to the fiber material,
d. Impregnating and consolidating the fiber material with the polymer composition to give a composite by action of temperatures not less than the melting temperature of the at least one polymer and pressure on the fiber material that has been contacted with micropelletized material,
e. cooling or solidification to obtain the composite structure.

Preferably, the present invention relates to an impregnation process for producing a single-layer semifinished fiber matrix product, comprising
a) providing 1 to 100 semifinished fiber product laminas composed of endless fibers, preferably 2 to 40 semifinished fiber product laminas composed of endless fibers, more preferably 2 to 10 semifinished fiber product laminas composed of endless fibers, where the semifinished fiber product laminas each have a basis weight in the range from 5 g/ma to 3000 g/m², preferably in the range from 100 g/m² to 900 g/m², particularly preferably in the range from 150 g/m² to 750 g/m²,
b) providing a polymer composition in the form of a micropelletized material, where the polymer composition has a melt volume flow rate MVR to ISO 1133 in the range from 50 cm³/10 min to 500 cm³/10 min, more preferably in the range from 50 cm³/10 min to 300 cm³/10 min, most preferably in the range from 100 cm³/10 min to 200 cm³/10 min, at a load of 5 kg and a temperature of 260° C.,
c) applying the micropelletized material to the totality of all semifinished fiber product laminas,
d) impregnating and consolidating the totality of all semifinished fiber product laminas with the polymer composition to give a composite by action of temperatures not less than the melting temperature of the polymer composition and pressure on the totality of all semifinished fiber product laminas that has been contacted with micropelletized material,
e) cooling or solidification to obtain the composite structure with a proportion by volume of fiber materials, defined in accordance with DIN 1310, in the range from 25% to 65%, preferably in the range from 30% to 55%, more preferably in the range from 40% to 50%, and a proportion by volume of air or gas, to be determined by density determination according to DIN EN ISO 1183, of less than 10%, preferably less than 5%,
   wherein a micropelletized material constitutes a pile of grains, the individual particles of which have greater or lesser homogeneity of grain size and are referred to as pellet grains or pellets, and these have a mean grain size, to be determined by means of dry sieve analysis according to DIN 53477, in the range from 0.01 to 3 mm.

Preferably, the present invention relates to an impregnation process for producing a semifinished fiber matrix product, comprising
a) providing 1 to 100 semifinished fiber product laminas composed of endless fibers, preferably 1 to 100 roving glass weave laminas composed of endless fibers,
b) providing a polyamide composition, preferably a nylon-6 composition, in the form of a micropelletized material,
c) applying the micropelletized material to the totality of all semifinished fiber product laminas, preferably roving glass weave laminas,
d) impregnating and consolidating the totality of all semifinished fiber product laminas, preferably roving glass weave laminas, with the polyamide composition to give a composite by action of temperatures not less than the melting temperature of the polyamide and pressure on the totality of all semifinished fiber product laminas, preferably roving glass weave laminas, that has been contacted with micropelletized material, and
e) cooling to obtain the composite structure,
   wherein a micropelletized material constitutes a pile of grains, the individual particles of which have greater or lesser homogeneity of grain size and are referred to as pellet grains or pellets, and these have a mean grain size, to be determined by means of dry sieve analysis according to DIN 53477, in the range from 0.01 to 3 mm.

More preferably, the present invention relates to an impregnation process for producing a single-layer semifinished fiber matrix product, comprising
a) providing a fiber material comprising endless fibers in the form of 1 to 100 semifinished fiber product laminas composed of endless fibers, preferably 2 to 40 semifinished fiber product laminas composed of endless fibers, more preferably 2 to 10 semifinished fiber product laminas composed of endless fibers, most preferably of roving glass weave laminas, where the semifinished fiber product laminas each have a basis weight in the range from 5 g/m² to 3000 g/m², preferably in the range from 100 g/m² to 900 g/m², particularly preferably in the range from 150 g/m² to 750 g/m²,
b) providing a nylon-6 composition in the form of a micropelletized material,
c) applying the micropelletized material to the totality of al semifinished fiber product laminas,
d) impregnating and consolidating the totality of all semifinished fiber product laminas with the polymer composition to give a composite by action of temperatures not less than the melting temperature of the nylon-6 composition and pressure on the totality of all semifinished fiber product laminas that has been contacted with micropelletized material,
e) cooling or solidification to obtain the composite structure with a proportion by volume of fiber materials, defined in accordance with DIN 1310, in the range from 25% to 65%, preferably in the range from 30% to 55%, more preferably in the range from 40% to 50%, and a proportion by volume of air or gas, to be determined by density determination according to DIN EN ISO 1183, of less than 10%, preferably less than 5%,
   wherein a micropelletized material constitutes a pile of grains, the individual particles of which have greater or lesser homogeneity of grain size and are referred to as pellet grains or pellets, and these have a mean grain size, to be determined by means of dry sieve analysis according to DIN 53477, in the range from 0.01 to 3 mm.

Semifinished fiber matrix products to be produced from micropelletized material in accordance with the invention can be used for a multitude of applications. They are preferably used in the automotive sector as components for passenger vehicles, heavy goods vehicles, commercial aircraft, in aerospace, in trains, but also for garden and domestic appliances, as computer hardware, in handheld electronic devices, in leisure articles and sports equipment, as structural components for machines, in buildings, in photovoltaic systems or in mechanical devices.

Finally, the present invention relates to the use of a polymer composition, preferably a polyamide composition, more preferably a nylon-6 composition, in the form of micropelletized material for production of a semifinished fiber matrix product, preferably a single-layer semifinished fiber matrix product comprising endless fibers.

### EXAMPLES

Using process steps a) to e) described, a semifinished fiber matrix product was produced, once with use in process step c) of ground polymer composition (comparative test) and once with use of polymer composition in the form of micropelletized material (inventive example).

The semifinished fiber product used was a 2/2 twill weave made of filament glass with silane size and a basis weight of 290 g/m².

The micropelletized material or the ground polymer composition was applied to the fiber materials in such amounts as to result in a proportion by volume of fiber materials in the semifinished fiber matrix product, defined according to DIN 1310, of 45%.

The semifinished fiber matrix products were produced by hot-pressing fiber material and thermoplastic matrix at temperatures in the range from 290-C to 320° C.
A) Powder (cryogenically ground) of a polymer composition based on polyamide with a mean grain size of 0.7 mm.
B) Micropelletized material (cylindrical form and ellipsoidal form) of a polymer composition based on polyamide with a mean grain size of 0.7 mm.

TABLE 1
Comparison of the results from powder application and micropelletized material application

| | A | B |
|---|---|---|
| | (comparative example) | (inventive example) |
| Purity of the polymer | − | + |
| composition | (powder had impurities after | (micropelletized material had |
| | the grinding) | no impurities) |
| Energy expenditure for | − | + |
| production of the semifinished | (relatively high energy | (relatively low energy |
| fiber matrix product | expenditure resulting from | expenditure in production of |
| | grinding operation and in | the semifinished fiber matrix |
| | production of the semifinished | product from micropelletized |
| | fiber matrix product) | material) |
| Evolution of dust in production | − | + |
| of the semifinished fiber matrix | (visible evolution of dust) | (no visible evolution of dust) |
| product | | |
| Absorption of moisture by the | − | + |
| polymer composition | (grinding material had a | (micropelletized material had a |
| | relatively high moisture level) | relatively low moisture level) |
| Surface quality of the | − | + |
| semifinished fiber matrix | (inhomogeneities apparent on | (fewer inhomogeneities |
| product | the surface) | apparent on the surface) |
| Tensile strength of the | − | + |
| semifinished fiber matrix | | (elevated tensile strength |
| product | | compared to comparative |
| | | example) |

### Delamination Test

To demonstrate that an inventive single-layer semifinished fiber matrix product has a lesser tendency to delaminate than a multilayer composite according to the prior art, test specimens were subjected to a mechanical test and this was used to determine the composite strength using tensile tests according to EN ISO 527 for determination of ultimate tensile stress, elongation at break and modulus of elasticity at a defined temperature. EN ISO 527-1 (latest edition of April 1996, current ISO version February 2012) is a European standard for a is for determination of tensile properties which are determined by a tensile test with a tensile tester. For this purpose, a specially designed test specimen holder was used, which enabled simple pushing-in and fixing of the cross-tension sample used as test specimen under tensile stress.

The testing was conducted on a Zwick UTS 50 tensile tester from Zwick GmbH & Co. KG, Ulm, with introduction of force by means of a mechanical clamping head. Each test specimen, referred to hereinafter as cross-tension sample, consisted of a semifinished fiber matrix product strip (55×40×2 mm³) onto which a fin (40×40×4 mm³) of nylon-6 had been injection-molded.

### Feedstocks

### Thermoplastic Matrix 1: Nylon-6 (PA6)

### Nylon-6:

Injection molding type, free-flowing, finely crystalline and very rapidly processible (BASF Ultramid® B3s), with a density of 1.13 g/cm³ and a melt flow index MVR of 160 cm³/10 min [test conditions: ISO1133, 5 kg, 275° C.] or a relative viscosity number (0.5% in 96% H₂SO₄, ISO 307, 1157, 1628) of 145 cm³/g.

### Thermoplastic Matrix 2: Nylon-6 (PA6)

### Nylon-6:

Film type, unreinforced, moderately free-flowing (BASF Ultramid® B33 L), with a density of 1.14 g/cm³ and a relative viscosity number (0.5% in 96% H₂SO₄, ISO 307, 1157, 1628) of 187-203 cm³/g.

### Semifinished Fiber Product

Balanced roving glass weaves (YPC ROF RE600) consisting of 1200 tax warp and waft filaments in a 2/2 twill weave with a thread density of 2.5 threads/cm. Total basis weight 600 g/m², with 50% in warp direction and 50% in weft direction. Weave width 1265 mm, roll length 150 lfm. Modification of the weft threads with specific size adapted to the polymer system (polyamide in the examples section).

### Semifinished Composite Product 1

Semifinished composite product 1 was produced in a static hotplate press. Semifinished composite product 1 with an edge length of 420 mm×420 mm consisted of 4 laminas of semifinished fiber product and an amount of polymer composed exclusively of thermoplastic matrix 1, which was applied and distributed homogeneously over the fiber laminas and resulted in a fiber volume content of 47% or in a thickness of 2.0 mm. For consolidation and impregnation, a surface pressure of 24 bar and a temperature of 300° C. were applied for 240 s. Subsequent cooling to room temperature was effected over 300 s at constant pressure. The semifinished fiber product laminas were thus homogeneously embedded in the resultant semifinished composite product 1 in sheet form; no material/phase boundaries formed within the matrix owing to the homogeneous single-layer matrix system; no physical distinction was possible between the inner embedding composition and surface.

### Semifinished Composite Product 2

Semifinished composite product 2, as an example of a multilayer construct according to the prior art, was likewise produced in a static hotplate press. The semifinished product intended for the multilayer construct with an edge length of 420 mm×420 mm consisted of 4 laminas of semifinished fiber product and an amount of polymer composed exclusively of thermoplastic matrix 1, which was applied and distributed homogeneously over the fiber laminas and resulted in a fiber volume content of 49% or in a thickness of 1.9 mm. For consolidation and impregnation, a surface pressure of 24 bar and a temperature of 300° C. were applied for 240 s. Subsequent cooling to room temperature was effected over 300 s at constant pressure.

In order to produce a layered construct, a 50 μm-thick film of thermoplastic matrix 2 was applied to each side of this semifinished product in a subsequent processing step. This again was effected in a static hotplate press at a temperature of 260° C. and a surface pressure of 9 bar that was maintained for 120 seconds. The cooling to room temperature within 60 s was effected at a surface pressure of 7.5 bar. Because of the different viscosities of the thermoplastic matrices 1 and 2, the structure of the composite material was inhomogeneous. Within the semifinished composite product 2 in sheet form that was produced in this way, the semifinished fiber laminas were embedded homogeneously in the matrix 1, whereas exclusively matrix 2 was present at the two surfaces, analogously to the semifinished products according to WO 2012/132 399 A1 and WO 2010/132 335 A1.

### Testing

The test specimen used for the mechanical testing of the composite adhesion between the semifinished composite product and thermoplastic that had been molded-on by injection molding was what is called a cross-tension sample. Each of these cross-tension test specimens consisted of a semifinished composite product strip (55×40×2 mm³) onto which a fin (40×40×4 mm³) of nylon-6 had been injection-molded. With regard to cross-tension samples see also W. Siebenpfeiffer, Leichtbau-Technologien im Automobilbau [Lightweight Construction Technologies in Automaking], Springer-Vieweg, 2014, pages 118-120. In the cross-tension test, the cross-tension sample is then clamped in a holder and subjected to a tensile force from one side. The tensile test is illustrated in a stress-strain diagram (modulus of elasticity).

For each of the cross-tension tests to be conducted in the context of the present invention, an inventive heated, unformed semifinished composite product 1 and also a semifinished composite product 2 of multilayer construction according to the prior art were each back-molded with a total of 22 Identical fins. The respective semifinished composite product 1 or 2 was previously provided with an 8 mm hole at the gate mark, in order that there was no additional resistance to the formation of fins for the polyamide melt to be molded on. After processing, individual sheet sections suitable for testing were cut out at selected positions along the flow pathway using a bandsaw of the “System Flott” type from Kräku GmbH, Groβseifen.

For mechanical testing of the composite strength, indices were determined from tensile tests on the cross-tension samples. In this case, a specially designed test specimen holder was used, which enabled simple pushing-in and fixing of the cross-tension sample under tensile stress. The testing was conducted on a Zwick UTS 50 tensile tester from Zwick GmbH & Co. KG, Ulm, with introduction of force by means of a mechanical clamping head. The parameters employed in the mechanical testing can be found in Table 2.

TABLE 2
Test parameters in the tensile test

| Test parameter | Value |
|---|---|
| State of the test specimens | dry |
| | (80° C. vacuum dryer, about 200 h) |
| Testing speed [mm/min] | 10 |
| Maximum force absorbed [kN] | 50 |
| Initial force [N] | 5 |

A criterion defined for the composite strength was the maximum force measured that was determined in the tensile test. The first measurable drops in force were caused by the first cracks in the material, detachment processes, deformations or similar effects prior to attainment of the maximum force, and seemed unsuitable as a criterion for composite strength. The maximum force measured was obtained on failure of the cross-tension sample; it is therefore referred to hereinafter as breaking force. In principle, it should be noted that the maximum force may depend not only on the composite bonding and the geometry but always also on the test method and test conditions.

For every semifinished composite product, 10 fin pull-off tests were conducted in each case in order to enable a statistically reliable conclusion.

### Experimental Results

In the case of the semifinished composite product 1 (inventive), in all cases, there was purely cohesive failure of the thermoplastic matrix 1 directly at the uppermost semifinished fiber product lamina of the semifinished fiber product.

In the case of the semifinished composite product 2 (noninventive), by contrast, there was always a mixed fracture consisting of cohesive and adhesive failure in the interface layer between thermoplastic matrix 1 and thermoplastic matrix 2. No cohesive failure of thermoplastic matrix 1 was found above the uppermost lamina of semifinished fiber product.

In the case of the noninventive semifinished composite product 2, the near-surface layer of thermoplastic matrix 2 was thus tom off the substrate consisting of semifinished fiber product and thermoplastic matrix 1, whereas, in the case of the inventive single-layer semifinished composite product 1, no such division was observed within a surface-parallel layer in the thermoplastic matrix 1.

TABLE 3
Statistical summary of 10 fin pull-off tests

| | Test result for semifinished | Test result for semifinished |
|---|---|---|
| No. | composite product 1 | composite product 2 |
| 1 | + | − |
| 2 | + | − |
| 3 | + | − |
| 4 | + | − |
| 5 | + | − |
| 6 | + | − |
| 7 | + | − |
| 8 | + | − |
| 9 | + | − |
| 10 | + | − |

The results are assessed according to the magnitude of the pull-off force. A “+” Indicates the higher pull-off force in each case for the two semifinished composite products compared with one another, whereas a “−” indicates the lower force, and a “+” symbolizes a pull-off force higher by at least 15%.

The test results show that the maximum force in the comparisons of the two semifinished composite products was always higher for the inventive single-layer semifinished composite product 1 than in the case of the semifinished composite product 2 with a layered construction. The mean value of the individual test results from the test series for the inventive single-layer semifinished composite product 1 was also well above that of the semifinished composite product 2.

In summary: the fin pull-off strength was distinctly higher for the inventive single-layer semifinished composite product 1 than for the semifinished composite product 2.

1. A process for producing a semifinished fiber matrix product, the process comprising:
applying a polymer composition in the form of a micropelletized material to a fiber material,
subjecting the fiber material with the applied polymer to a temperature and pressure, and period of time sufficient to impregnate the polymer composition into the fiber material and consolidate the polymer composition with the fiber material to produce a composite, and
cooling the composite to obtain a semifinished fiber matrix product.

2. The process as claimed in claim 1, wherein:
the temperature is equal to or greater than the melting temperature of the polymer composition,
the pressure is 2 to 100 bar; and
the fiber material comprises a semifinished fiber product or a nonwoven structure.

3. The process as claimed in claim 2, wherein the fiber material is a semifinished fiber product and is selected from the group consisting of weaves, laid scrims including multiaxial laid scrims, knits, braids, nonwovens, felts, mats or unidirectional fiber strands, a mixture of two or more of these materials, and combinations thereof.

4. The process as claimed in claim 1, wherein the polymer composition comprises at least one thermoplastic selected from the group consist of polyamide (PA), polycarbonate (PC), thermoplastic polyurethane (TPU), polybutylene terephthalate (PBT), polyphenylene sulfide (PPS), polyphthalamide (PPA), polypropylene (PP), polyethylene terephthalate (PET), polyethylene (PE), polylactic acids (PLA), acrylonitrile-butadiene-styrene (ABS), styrene-acrylonitrile (SAN), polyether ether ketone (PEEK), polyether imide (PEI), polyether sulfone (PES), polymethylmethacrylate (PMMA), polyoxymethylene (POM), and polystyrene (PS), and derivatives and blends thereof.

5. The process as claimed in claim 1, wherein the polymer composition comprises at least one addition or additive.

6. The process as claimed in claim 5, wherein the additives comprise ultraviolet light stabilizers, flame retardants, leveling-promoting additives, lubricants, antistats, colorants, nucleators, crystallization promoters, fillers, or other processing auxiliaries, or mixtures thereof.

7. The process as claimed in claim 1, wherein the micropelletized material has a mean grain size of 0.01 to 3 mm, determined by means of dry sieve analysis according to DIN 53477.

8. The process as claimed in claim 1, wherein the micropellets are round, ellipsoidal, cubic or cylindrical.

9. The process as claimed in claim 1, wherein the micropelletized material has a bulk density of 200 to 1800 g/L, determined according to EN ISO 60.

10. The process as claimed in claim 1, wherein the micropellets have a residual moisture content of not more than 0.3% by weight, based on the total weight of the micropellets.

11. The process as claimed in claim 1, wherein the micropellets have a Shore A hardness of more than 90°, and have a Shore D hardness of more than 60°, where the Shore hardness is determined according to DIN 43505 with test instrument A or test instrument D.

12. The process as claimed in claim 1, further comprising applying multiple layers of the micropelletized material to the fiber material.

13. The process as claimed in claim 1, further comprising applying the micropelletized material to the fiber material in an amount sufficient to result in a semifinished fiber matrix product having 25% to 80% fiber material as defined according to DIN 1310.

14. The process as claimed in claim 1, wherein the semifinished fiber matrix product is a single-layer semifinished fiber matrix product.

15. A method for producing a semifinished fiber matrix product, the method comprising impregnating and bonding two or more layers of a fiber material with a polymer composition in the form of micropellets.

16. A single-layer semifinished fiber matrix product comprising at least one fiber material impregnated and consolidated with a polymer composition in the form of a micropelletized material at a temperature and pressure sufficient to impregnate and consolidate the polymer composition into and with the fiber material.

17. The single-layer semifinished fiber matrix product as claimed in claim 16, wherein:
fiber matrix product has 25 vol % to 65 vol % fiber material as defined according to DIN 1310
the fiber matrix product has a fiber distribution gradient from the surface to the middle, and the distribution gradient differs by at most 5% from the surface to the middle;
the fiber matrix product has a gas cavity content of less than 10 vol % based on the overall volume of the product;
the fiber material comprises 1 to 100 semifinished fiber laminas comprising endless fibers, the laminas each having a basis weight of 5 g/m² to 3000 g/m² and being selected from the group consisting of weaves, laid scrims including multiaxial laid scrims, knits, braids, nonwovens, felts, mats or unidirectional fiber strands, a mixture of two or more of these materials, and combinations thereof;
the polymer composition has a melt volume flow rate MVR to ISO 1133 of 50 cm³/10 min to 500 cm³/10 min at a load of 5 kg and a temperature of 260° C., and comprises at least one thermoplastic selected from the group consisting of polyamide (PA), polycarbonate (PC), thermoplastic polyurethane (TPU), polybutylene terephthalate (PBT), polyphenylene sulfide (PPS), polyphthalamide (PPA), polypropylene (PP), polyethylene terephthalate (PET), polyethylene (PE), polylactic acids (PLA), acrylonitrile-butadiene-styrene (ABS), styrene-acrylonitrile (SAN), polyether ether ketone (PEEK), polyether imide (PEI), polyether sulfone (PES), polymethylmethacrylate (PMMA), polyoxymethylene (POM), and polystyrene (PS), and derivatives and blends thereof; and
the micropelletized material has a mean grain size of 0.01 to 3 mm.

18. The single-layer semifinished fiber matrix product as claimed in claim 17, wherein:
the fiber matrix product has 40 vol % to 50 vol % fiber material as defined according to DIN 1310;
the fiber distribution gradient differs by at most 3% from the surface to the middle;
the gas cavity content is less than 5 vol % based on the overall volume of the product;
the melt volume flow rate is 100 cm³/10 min to 200 cm³/10 min;
the polymer composition comprises at least one thermoplastic from the group consisting of polypropylene (PP), polyamide (PA), polycarbonate (PC), polybutylene terephthalate (PBT) and polyethylene terephthalate (PET), and derivatives and blends thereof;
the fibers are glass fibers and/or carbon fibers; and
the single-layer semifinished fiber matrix product is produced by a process comprising:
applying the polymer composition in the form of the micropelletized material to the fiber material in an amount sufficient to result in a semifinished fiber matrix product having 25% to 65% fiber material as defined according to DIN 1310,
subjecting the fiber material with the applied polymer to the temperature and pressure sufficient to impregnate and consolidate the polymer composition into the fiber material to produce a composite, and
cooling the composite to obtain the semifinished fiber matrix product.

19. The process as claimed in claim 1, wherein:
the temperature is equal to or greater than the melting temperature of the polymer composition;
the pressure is 2 to 100 bar;
the fiber material is a semifinished fiber product comprising 2 or more layers of the fiber materials, wherein the fiber materials comprise at least one of carbon fibers and glass fibers, and the materials are selected from the group consisting of weaves, laid scrims including multiaxial laid scrims, knits, braids, nonwovens, felts, mats or unidirectional fiber strands, a mixture of two or more of these materials, and combinations thereof;
the polymer composition comprises at least one thermoplastic selected from the group consisting of polyamide (PA), polycarbonate (PC), thermoplastic polyurethane (TPU), polybutylene terephthalate (PBT), polyphenylene sulfide (PPS), polyphthalamide (PPA), polypropylene (PP), polyethylene terephthalate (PET), polyethylene (PE), polylactic acids (PLA), acrylonitrile-butadiene-styrene (ABS), styrene-acrylonitrile (SAN), polyether ether ketone (PEEK), polyether imide (PEI), polyether sulfone (PES), polymethylmethacrylate (PMMA), polyoxymethylene (POM), and polystyrene (PS), and derivatives and blends thereof; and
the micropelletized material has a mean grain size of 0.01 to 3 mm.

20. The process as claimed in claim 19, wherein:
the temperature is at least 20° C. greater than the melting temperature of the polymer composition, and the pressure is 10 to 40 bar;
the polymer composition comprises at least one addition or additive selected from the group consisting of ultraviolet light stabilizers, flame retardants, leveling-promoting additives, lubricants, antistats, colorants, nucleators, crystallization promoters, fillers, and other processing auxiliaries, or mixtures thereof;
the micropellets are round, ellipsoidal, cubic or cylindrical, and have:
a bulk density of 200 to 1800 g/L, determined according to EN ISO 60;
a residual moisture content of not more than 0.3% by weight based on the total weight of the micropellets;
a Shore A hardness of more than 90° determined according to DIN 43505 with test instrument A; and
a Shore D hardness of more than 60° determined according to DIN 43505 with test instrument D;
the micropelletized material is applied to the fiber materials by at least one of scattering, tricking, printing, spraying, irrigating, thermal spraying, flame spraying, and fluidized bed coating processes; and
the process further comprises, after application of the micropelletized polymer to the fiber material, scintering the micropeletized polymer, optionally under pressure, at a temperature below the melting temperature of the polymer.
